(19) United States
(12) Patent Application Publication
(10) Pub. No.: US 2007/0210008 A1
(43) Pub. Date: Sep. 13, 2007

(54) FILTER MONITOR

(76) Inventors: Gregory Scott Sprenger, Colorado Springs, CO (US); David Stanley Hawkins, Colorado Springs, CO (US); Michael Joseph Gish, Colorado Springs, CO (US); Jed Babbington Stevens, Colorado Springs, CO (US)

Correspondence Address: FRASER CLEMENS MARTIN & MILLER LLC, 28366 KENSINGTON LANE, PERRYSBURG, OH, 43551, US

(21) Appl. No.: 11/682,605

(22) Filed: Mar. 6, 2007

Related U.S. Application Data
(60) Provisional application No. 60/782,174, filed on Mar. 13, 2006.

(51) Int. Cl. C02F 1/00

(52) U.S. Cl. 210/746

(57) ABSTRACT

A filter monitor is disclosed capable of sensing the presence of water in the filter. The sensor utilizes changes in capacitance of a water absorbing media which functions as a dielectric disposed between a pair of electrodes. The sensor is in communication with a valve means to interrupt the transient fluid when a predetermined amount of water is present in the fluid.

### CROSS-REFERENCE TO RELATED APPLICATION

This application claims the benefit of U.S. Provisional Patent Application Ser. No. 60/782,174 filed on Mar. 13, 2006.

### FIELD OF THE INVENTION

The invention relates to an apparatus and a method for detecting the presence of water in a hydrocarbon fluid.

### BACKGROUND OF THE INVENTION

The presence of water in hydrocarbon fluids, such as used in aviation fuel, for example, has presented a problem for many years. Various types of systems are available for the analysis of fuel to determine the presence of water.

Presently, fuel filter monitors are employed to sense water in hydrocarbon fluids. Such monitors typically may include super absorbent polymers which absorb water that was present in transient fuel streams. While these systems have been reliable, it has been discovered that a degradation of water absorption occurs after an extended period of service. Also, it has been found that undesirable downstream migration of the super absorbent polymers has taken place under certain conditions.

It would be desirable to produce a fuel filter monitor utilizing changes in electrical capacitance of the water absorbing media of the monitor to sense the presence of water in a transient flow of fuel and to stop the fuel flow when an excessive amount of water is sensed.

### SUMMARY OF THE INVENTION

Harmonious with the present invention, a fuel filter monitor utilizing changes in capacitance of the water absorbing media of the monitor to sense the presence of water in a transient flow of fuel and to stop the fuel flow when an excessive amount of water is sensed, has surprisingly been discovered.

In one embodiment, a fuel filter monitor for sensing contaminants in a transient flow of hydrocarbon fluid comprises: a capacitance sensor; and a pair of spaced apart electrodes in communication with the capacitance sensor, the electrodes having a dielectric medium interdigitated therebetween, the medium capable of absorbing contaminants in the hydrocarbon fluid to vary the capacitance between the electrodes.

In another embodiment, a fuel filter monitor for sensing water in a transient flow of hydrocarbon fluid comprises: a filter cartridge; a capacitance sensor; and a pair of spaced apart electrodes in communication with the capacitance sensor and disposed in the filter cartridge, the electrodes having a dielectric medium interdigitated therebetween, the medium capable of absorbing contaminants in the hydrocarbon fluid to vary the capacitance between the electrodes.

A method for monitoring the presence of water in a transient flow of hydrocarbon fluid is disclosing comprising the steps of: providing a capacitance sensor in communication with a pair of spaced apart electrodes having a dielectric media interdigitated therebetween; causing a flow of transient fluid to flow through the spaced apart electrodes and the dielectric media; and sensing a capacitance of the flow between the electrodes.

### BRIEF DESCRIPTION OF THE DRAWINGS

The above and other objects and advantages of the invention will become readily apparent to those skilled in the art from reading the following descriptions of several embodiments of the invention when considered in the light of the accompanying drawings, in which:

FIG. 1 is an enlarged fragmentary sectional view of an end cap disposed in an outside-in flow filter cartridge incorporating the present invention;

FIG. 2 is a perspective sectional view of a fuel filter vessel in an open position including the filter cartridge illustrated in FIG. 1; and

FIG. 3 is an enlarged fragmentary sectional view of a seal plate used to seal a filter cartridge in accordance with another embodiment of the invention.

### DETAILED DESCRIPTION OF THE PREFERRED EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed and illustrated, the steps presented are exemplary in nature, and thus, the order of the steps is not necessary or critical.

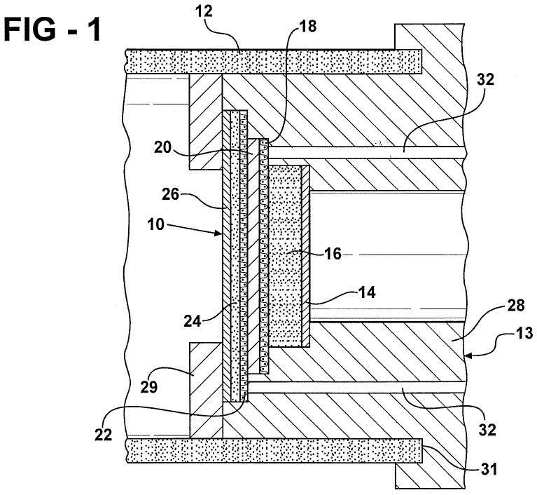

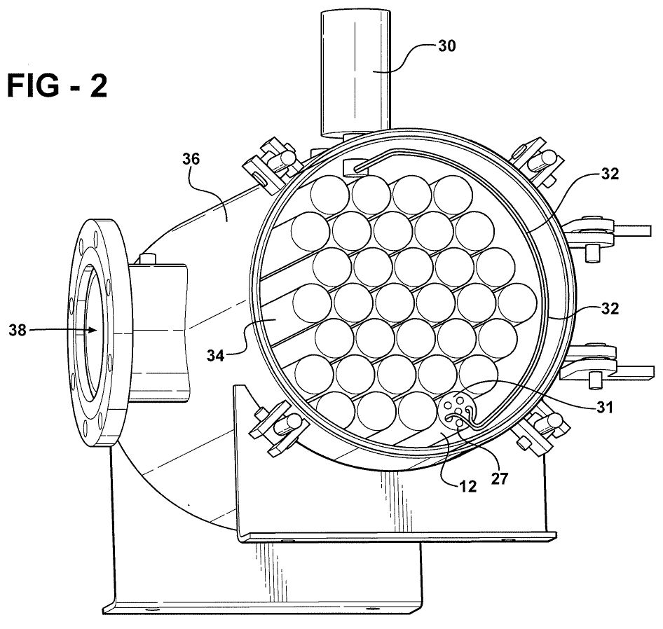

FIG. 1 shows a filter monitor, generally indicated by reference numeral 10, capable of sensing the presence of water in a hydrocarbon fluid flowing through a filter cartridge 12. The filter cartridge 12 is an outside-in flow type filter employed to remove particulate contaminants from hydrocarbon fluid such as aviation fuel, for example. The filter monitor 10, which is embedded in a filter cartridge end cap 13, includes a first fluid pervious structural support 14, a first filter medium 16, a first fluid pervious electrode 18, a water absorbing dielectric medium 20, a second fluid pervious electrode 22, a second filter medium 24, and a second fluid pervious structural support 26 disposed in a stacked relationship. A plurality of inlet apertures 27, as shown in FIG. 2, is formed in the filter cartridge end cap 13 to permit the flow of fluid therethrough.

In the embodiment shown, a first portion 28 and a second portion 29 cooperate to form the filter cartridge end cap 13. The first portion 28 can be joined to the second portion 29 by any means, such as a snap-fitting or a gluing, for example. It is understood that the filter cartridge end cap 13 can be formed from one integral piece as desired. While the filter monitor 10 has been shown embedded in the filter cartridge end cap 13, the filter monitor 10 can be disposed in a position intermediate a first end 31 and a spaced apart second end (not shown) of the filter cartridge 12 as desired.

The structural supports 14 and 26 may be formed from any suitable material such as metal or plastic, and include a plurality of spaced apart apertures formed therein for allowing the flow of fluid therethrough.

The filter media 16 and 24 can be formed from any suitable filtering material such as a fiberglass, for example.

The water absorbing dielectric medium 20 can be any water absorbing material as desired, such as cellulose, for example.

In use, the fluid is caused to flow into the filter cartridge 12 through the inlet apertures 27 formed in the filter cartridge end cap 13 and through the apertures formed in the first structural support 14. The fluid then flows through the first filter medium 16 where contaminants are removed therefrom. Thereafter, the fluid flows through the first electrode 18 and through the water absorbing dielectric medium 20 where water that may be present in the fluid is absorbed. The fluid then flows through the second electrode 22. It should be understood that the first electrode 18, the water absorbing dielectric medium 20, and the second electrode 22 cooperate to sense a capacitance of the fluid flowing therethrough. The capacitance is transmitted to a capacitance sensor 30 through a pair of electrical leads 32. After flowing through the second electrode 22, the fluid flows through the second filter medium 24 where additional contaminants are removed therefrom. Subsequently, the fluid flows out of the filter monitor 10 through the apertures formed in the second structural support 26. It should be appreciated that the fluid flows into the filter cartridge 12 through an outer wall thereof in an outside-in orientation in addition to flowing into the filter cartridge 12 through the inlet apertures 27 formed in the filter cartridge end cap 13.

When water is present in the flowing fluid, the water absorbing dielectric medium 20 displaces some fuel along with the absorbed water. This generates a capacitance increase, since the dielectric constant of water (80) is much larger than that of fuel (approx. 2.5). The capacitance increase is sensed by the capacitance sensor 30. The capacitance sensor 30 is configured to trigger appropriate valves (not shown) to stop the flow of fluid if the capacitance increase reaches a predetermined level. The predetermined level can be determined through experimental testing, for example. Since the electrical leads 32 carry the signal from the filter monitor 10, the capacitance sensor 30 can be positioned remotely therefrom.

It has been found that the performance of the water absorbing dielectric medium 20 can be maximized by adding a small amount of super absorbent polymer material therein. The polymer material is a better absorber of water than cellulose and therefore maximizes the increase in capacitance. In addition, the polymer regulates the capacitance, since the release of the water back into the fuel is slowed. However, it may be desirable to eliminate all super absorbent polymers from the monitor, in which case cellulose media may be used as described above.

In practice, multiple filter cartridges 34 are typically used in a single vessel 36 as shown in FIG. 2. The fluid flows into the vessel 36 through the fluid inlet 38. Thereafter, the fluid flows through the outer walls of the filter cartridges 34, through the outer wall of the filter cartridge 12, and through the inlet apertures 27 formed in the filter cartridge end cap 13. Since parallel flow through the vessel 36 occurs, only one filter cartridge 12 including the filter monitor 10 need be used. The rest of the filter cartridges 34 would normally have identical structure and filter media, but without the filter monitor 10 and filter cartridge end cap 13. It is understood that additional filter cartridges 12 including filter monitors 10 may be used as desired.

The electrical leads 32, which can be molded into the filter cartridge end cap 13, provide an easy “plug-in” type connection from the capacitance sensor 30 to the filter monitor 10. Accordingly, the filter monitor 10 can be removed and replaced as desired.

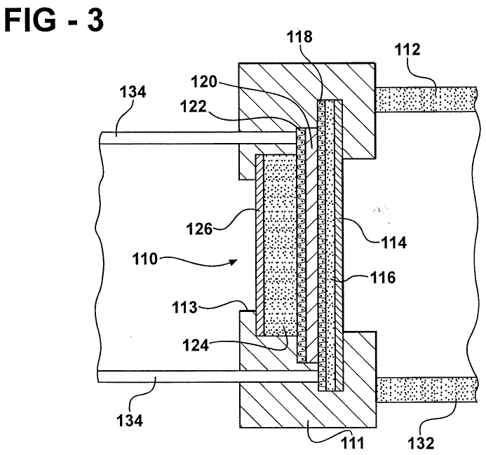

FIG. 3 shows a filter monitor 110 embedded into a seal plate 111 used to seal a filter cartridge 112. In this embodiment, the seal plate 111 is used in the place of the filter cartridge end cap 13 as described above for FIG. 1, and includes at least one aperture 113 formed therein for permitting a flow of fuel therethrough. The filter monitor 110 includes a first fluid pervious structural support 114, a first filter medium 116, a first fluid pervious electrode 118, a water absorbing dielectric medium 120, a second fluid pervious electrode 122, a second filter medium 124, and a second fluid pervious structural support 126 disposed in a stacked relationship. The filter cartridge 112 could be oriented with an outside-in flow, which is typical, or with an inside-out flow. The filter monitor 110 could be a replaceable unit to allow the reuse of the seal plate 111. Electrical leads 134, which can be molded into the seal plate 111, provide an easy “plug-in” type connection from an electric circuit (not shown) to the filter monitor 110, as described above.

Use of the filter monitor 110 is similar to that described above for FIG. 1, wherein the fuel flows into the filter cartridge 112 through the aperture 113 formed in the seal plate 111. It should be appreciated that the fuel flows into the filter cartridge 112 through an outer wall thereof in an outside-in orientation in addition to flowing into the filter cartridge 112 through the aperture 113 formed in the seal plate 111.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A fuel filter monitor for sensing contaminants in a transient flow of hydrocarbon fluid comprising:
a capacitance sensor; and
a pair of spaced apart electrodes in communication with the capacitance sensor, the electrodes having a dielectric medium interdigitated therebetween, the medium capable of absorbing contaminants in the hydrocarbon fluid to vary the capacitance between the electrodes.

2. The fuel filter monitor as defined in claim 1, wherein the electrodes are disposed in a filter cartridge.

3. The fuel filter monitor as defined in claim 2, wherein the filter cartridge includes an end cap containing the electrodes.

4. The fuel filter monitor as defined in claim 2, further comprising a seal plate sealing an end of the filter cartridge and containing the electrodes.

5. The fuel filter monitor as defined in claim 1, wherein the capacitance sensor is adapted to communicate with a valve for militating against the flow of fluid.

6. The fuel filter monitor as defined in claim 1, wherein the medium is formed from cellulose.

7. The fuel filter monitor as defined in claim 1, wherein the medium includes an amount of super absorbent polymer material.

8. The fuel filter monitor as defined in claim 1, further comprising a first filter medium disposed upstream of the electrodes.

9. The fuel filter monitor as defined in claim 8, further comprising a second filter medium disposed downstream of the electrodes.

10. A fuel filter monitor for sensing water in a transient flow of hydrocarbon fluid comprising:
a filter cartridge;
a capacitance sensor; and
a pair of spaced apart electrodes in communication with the capacitance sensor and disposed in the filter cartridge, the electrodes having a dielectric medium interdigitated therebetween, the medium capable of absorbing contaminants in the hydrocarbon fluid to vary the capacitance between the electrodes.

11. The fuel filter monitor as defined in claim 10, wherein the filter cartridge includes an end cap containing the electrodes.

12. The fuel filter monitor as defined in claim 10, further comprising a seal plate sealing an end of the filter cartridge and containing the electrodes.

13. The fuel filter monitor as defined in claim 10, wherein the capacitance sensor is adapted to communicate with a valve for militating against the flow of fluid.

14. The fuel filter monitor as defined in claim 10, wherein the medium is formed from cellulose.

15. The fuel filter monitor as defined in claim 10, wherein the medium includes an amount of super absorbent polymer material.

16. The fuel filter monitor as defined in claim 10, further comprising a first filter media disposed upstream of the electrodes.

17. The fuel filter monitor as defined in claim 16, further comprising a second filter media disposed downstream of the electrodes.

18. A method for monitoring the presence of water in a transient flow of hydrocarbon fluid comprising the steps of:
providing a capacitance sensor in communication with a pair of spaced apart electrodes having a dielectric media interdigitated therebetween;
causing a flow of transient fluid to flow through the spaced apart electrodes and the dielectric media; and
sensing a capacitance of the flow between the electrodes.

19. The method for monitoring the presence of water as defined in claim 18, wherein the electrodes are disposed in a filter cartridge.

20. The method for monitoring the presence of water as defined in claim 18, further comprising the step of militating against the flow upon the capacitance of the flow reaching a predetermined level.
